(19) United States
(12) Patent Application Publication
(10) Pub. No.: US 2021/0273289 A1
(43) Pub. Date: Sep. 2, 2021

(54) BATTERY CELL PRESSURE FIXTURE

(71) Applicant: Follicle, Inc., Milwaukee, WI (US)

(72) Inventors: Jason E. Torres, San Francisco, CA (US); Erik I. Stafl, San Francisco, CA (US)

(73) Assignee: Follicle, Inc., Milwaukee, WI (US)

(21) Appl. No.: 17/249,268

(22) Filed: Feb. 25, 2021

Related U.S. Application Data
(60) Provisional application No. 62/983,516, filed on Feb. 28, 2020.

(51) Int. Cl. H01M 50/367; H01M 50/209

(52) U.S. Cl. CPC H01M 50/367; H01M 50/209

(57) ABSTRACT

A battery cell pressure fixture is provided that includes a fluid cavity for receiving a fluid pressure, an expandable bladder having a plurality of pillars with pillar inner chambers in communication with the fluid cavity, a plurality of battery cell mounts positioned adjacent the pillars, and a plurality of battery receptacles for receiving battery cells therein, the battery receptacles formed at least in part by the pillars and the battery cell mounts, wherein each battery receptacle provides a compressive force to a received battery cell positioned therein when fluid pressure is supplied to the fluid cavity.

### CROSS-REFERENCE TO RELATED APPLICATION

This application claims priority to U.S. Provisional Patent Appl. No. 62/983,516 filed on Feb. 28, 2020, the disclosure of which is incorporated herein by reference in entirety for all purposes.

### FIELD OF THE INVENTION

The battery cell pressure fixture relates generally to the field of battery cell manufacturing. More particularly, the battery cell pressure fixture relates to stabilizing battery cells during production.

### BACKGROUND

A critical part of the lithium-ion battery manufacturing process occurs after the battery cells are initially assembled. Battery cells are assembled in an uncharged state and must be given an initial charge. During the initial charge phase, the materials inside the battery cell, namely the electrodes and electrolytes, change their physical size and shape as ions move between the electrode and electrolyte within the cell. In particular, the battery cells, especially pouch cells, swell during initial charge. As a result, there is a need to constrain the battery cells during their initial charge cycle to reduce the possibility of gapping or other issues that could affect the long-term safety and viability of the cells.

Existing solutions for constraining battery cells during initial charging typically include a fixture that can support numerous cells at once. Movable rigid plates are positioned between groups of cells to provide a constricting barrier. The rigid plates are moved using worm gears, springs, or other mechanical means that cause the rigid plates to apply uneven pressure to the cells. More particularly, each rigid plate is moved the same distance, which creates identical battery cavities where each cell is placed. However, each cell is manufactured to tolerance, and although those tolerances may be very small, there is variation in cell size, nonetheless. As such, the mechanically driven plates do not apply uniform pressure to each cell. Rather, larger cells experience higher pressures than cells on the smaller side of the allowable tolerance. As such, there is a need for an improved fixture for applying pressure to individual battery cells during production.

It will be understood by those skilled in the art that one or more aspects of this invention can meet certain objectives, while one or more other aspects can lead to certain other objectives. Other objects, features, benefits and advantages of the battery cell pressure fixture will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### SUMMARY OF THE INVENTION

In at least some embodiments, a battery cell pressure fixture is disclosed that includes a fluid cavity for receiving a fluid pressure, an expandable bladder having a plurality of pillars with pillar inner chambers in communication with the fluid cavity, a plurality of battery cell mounts positioned adjacent the pillars, and a plurality of battery receptacles for receiving battery cells therein, the battery receptacles formed at least in part by the pillars and the battery cell mounts, wherein each battery receptacle provides a compressive force to a received battery cell positioned therein when fluid pressure is supplied to the fluid cavity.

In at least some other embodiments, a battery cell pressure fixture is disclosed that includes a lower tray; an upper tray having an upper tray top surface and a plurality of pillar slots extending therethrough; a plurality of battery cell mounts, each having an elongated cell mount support wall and extending from the upper tray top surface; and a resilient fluid expansive bladder for receiving a supply of pressurized fluid and having a base with a plurality of pillars extending from a base top surface, wherein the base is positioned between the lower tray and the upper tray, and the pillars extend upward through the pillar slots opposite the lower tray.

In at least some other embodiments, a battery cell pressure fixture is disclosed that includes lower tray; an upper tray having an upper tray top surface and a plurality of pillar slots extending therethrough, wherein the upper tray is secured to the lower tray; a plurality of battery cell mounts, each having an elongated cell mount support wall and extending from the upper tray top surface; a first resilient fluid expansive bladder for receiving a supply of pressurized fluid and having a base with a plurality of pillars extending from a base top surface, wherein the base is positioned between the lower tray and the upper tray, and the pillars extend upward through the pillar slots opposite the lower tray; a plurality of fluid apertures that extend from a base of the bladder into pillar inner chambers of the plurality of pillars; and a plurality of battery receptacles for receiving battery cells therein, the battery receptacles formed by the upper tray, the pillars, and the battery cell mounts, and wherein the pillars expand under fluid pressure applied to the pillar inner chambers to provide a uniform compressive force to the battery cells.

Other embodiments, aspects, and features of the invention will be understood and appreciated upon a full reading of the detailed description and the claims that follow.

### BRIEF DESCRIPTION OF THE DRAWINGS

Embodiments of the invention are disclosed with reference to the accompanying drawings and are for illustrative purposes only. The invention is not limited in application to the details of construction or the arrangement of the components illustrated in the drawings. The invention is capable of other embodiments or of being practiced or carried out in other various ways.

FIG. 1 is a front top perspective view of an exemplary embodiment of a battery cell pressure fixture.

FIG. 2 is a rear top perspective view of the battery cell pressure fixture of FIG. 1.

FIG. 3 is a rear bottom perspective view of the battery cell pressure fixture of FIG. 1.

FIG. 4 is a side view of the battery cell pressure fixture of FIG. 1.

FIG. 5 is top view of the battery cell pressure fixture of FIG. 1.

FIG. 6 is a cross-sectional view of the battery cell pressure fixture of FIG. 1, taken generally along the line 6-6 of FIG. 5.

FIG. 7 is an exploded top perspective view of the battery cell pressure fixture of FIG. 1.

FIG. 8 is an exploded bottom perspective view of the battery cell pressure fixture of FIG. 1.

FIG. 9 is a front perspective view of an exemplary bladder of the fixture of FIG. 1.

FIG. 10 is a bottom perspective view of the bladder of FIG. 9.

FIG. 11 is a top view of the bladder of FIG. 9.

FIG. 12 is a front perspective view of another exemplary bladder of the fixture of FIG. 1.

FIG. 13 is a bottom perspective view of the bladder of FIG. 12.

FIG. 14 is top view of an exemplary upper tray of the fixture of FIG. 1.

FIG. 15 is bottom view of the upper tray of FIG. 14.

FIG. 16 is top view of an exemplary bottom tray of the fixture of FIG. 1.

FIG. 17 is a front view of an exemplary battery cell mount of the fixture of FIG. 1.

FIG. 18 is a rear top perspective view of the battery cell mount of FIG. 17.

FIG. 19 is a front bottom perspective view of the battery cell mount of FIG. 17.

FIG. 20 is a perspective view of an exemplary support bar of the fixture of FIG. 1.

FIG. 21 is a front perspective view of an exemplary end plate of the fixture of FIG. 1.

FIG. 22 is rear top perspective view of an exemplary prior art battery cell.

FIG. 23 is front bottom perspective view of the battery cell of FIG. 22.

FIG. 24 is a top view of the battery cell pressure fixture of FIG. 1 with a plurality of battery cells positioned therein.

FIG. 25 is a side view of the battery cell pressure fixture of FIG. 24 with the plurality of battery cells positioned therein.

FIG. 26 is a cross-sectional view of the battery cell pressure fixture taken generally along line 26-26 of FIG. 24.

### DETAILED DESCRIPTION

The invention relates to a fixture to constrain battery cells, such as lithium-ion, lithium-polymer, etc., during their initial charge by applying even pressure to the cells. The configuration of the fixture allows for a resilient fluid expansive bladder to be filled with fluid to evenly apply pressure to each battery cell present in the fixture.

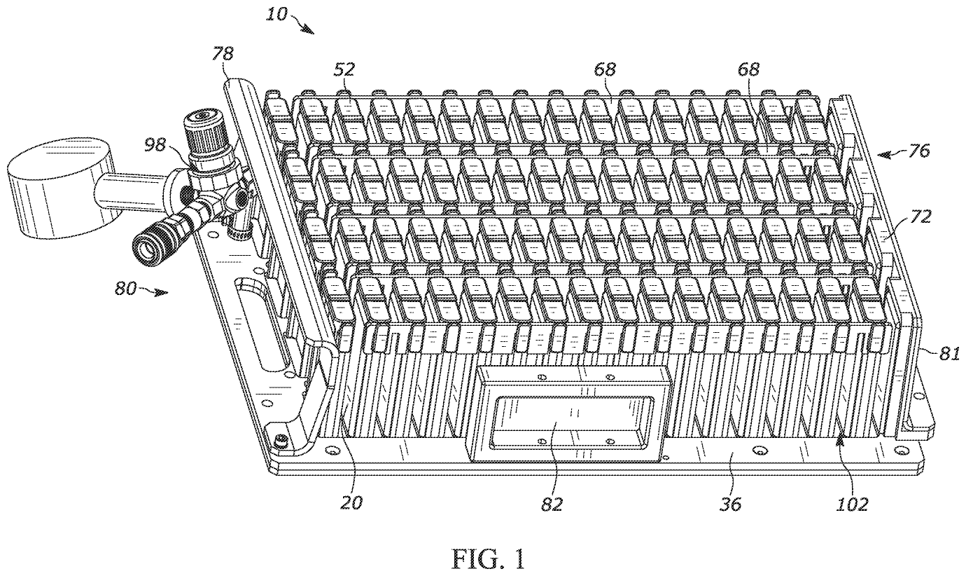

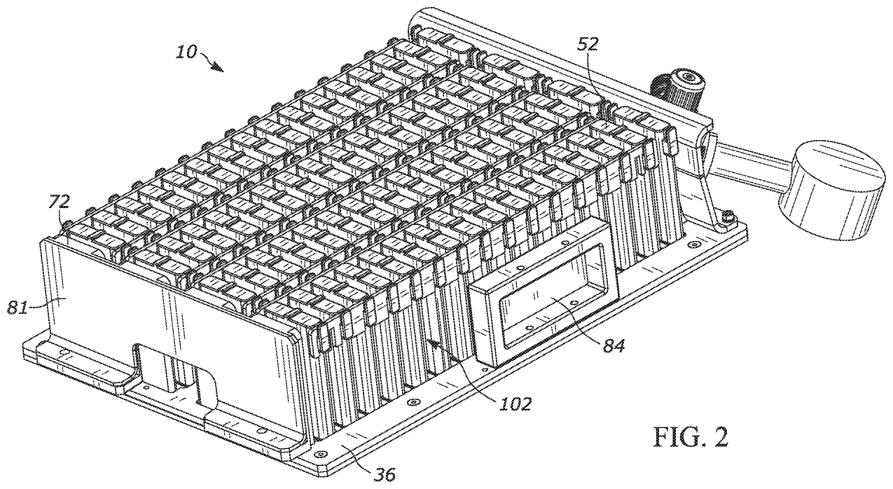

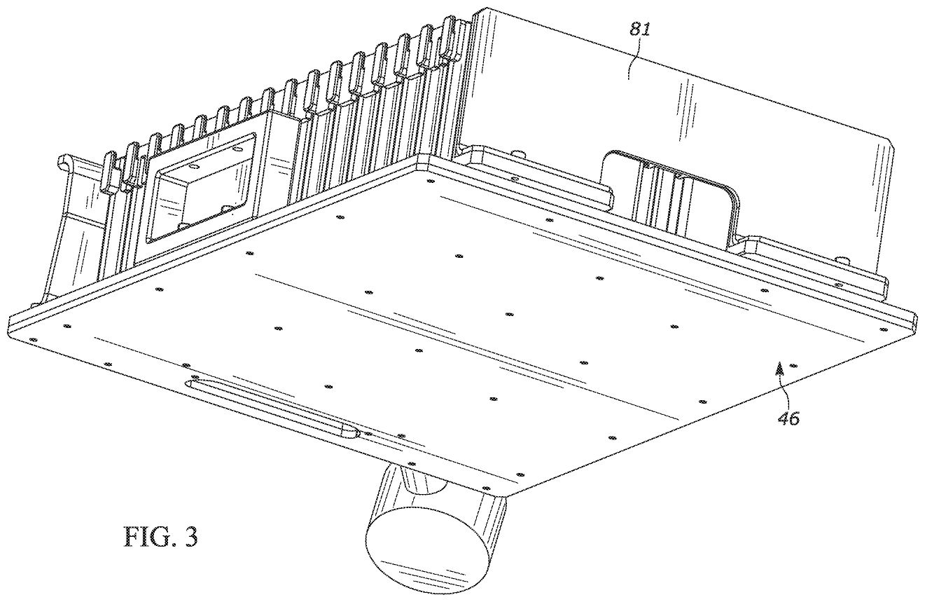

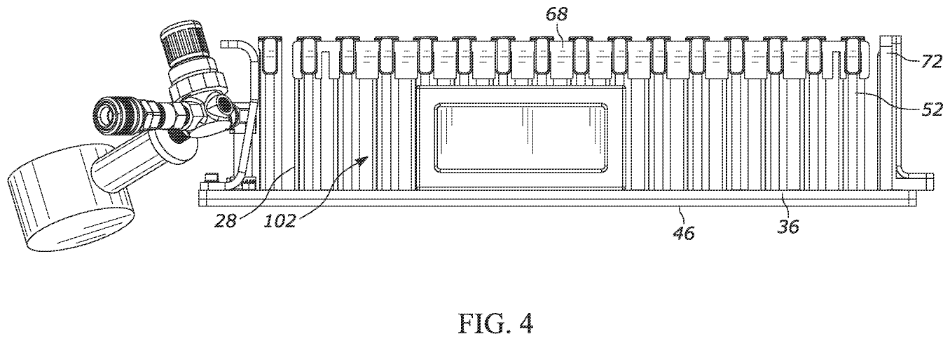

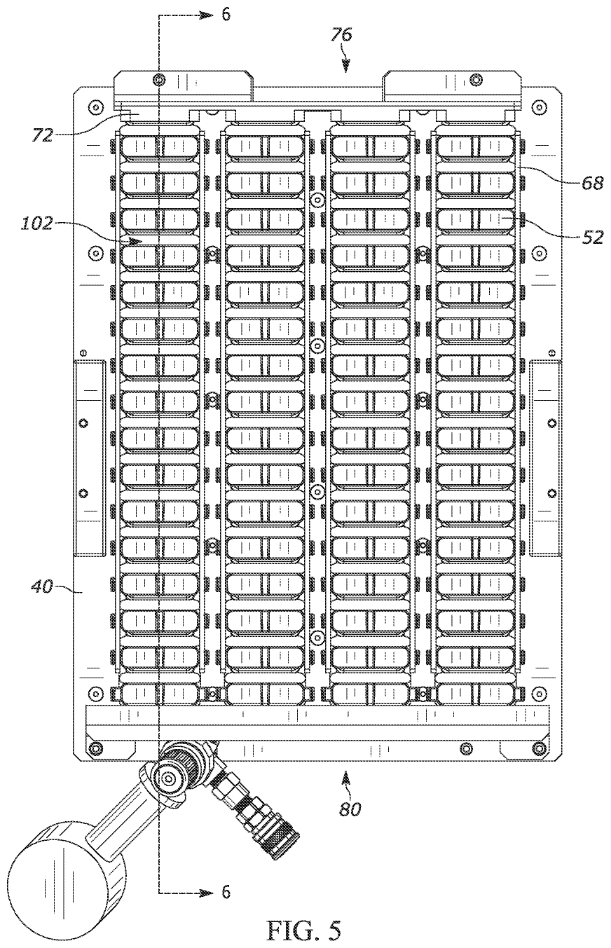

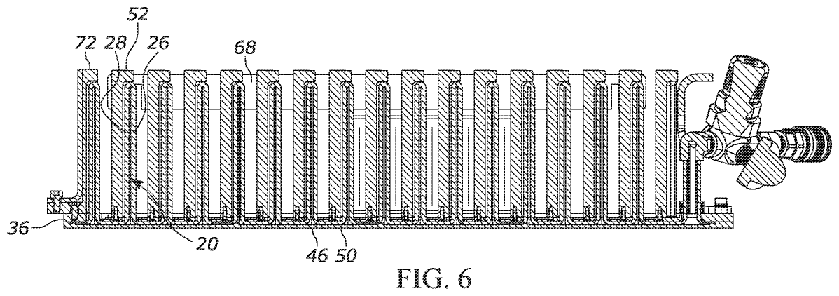

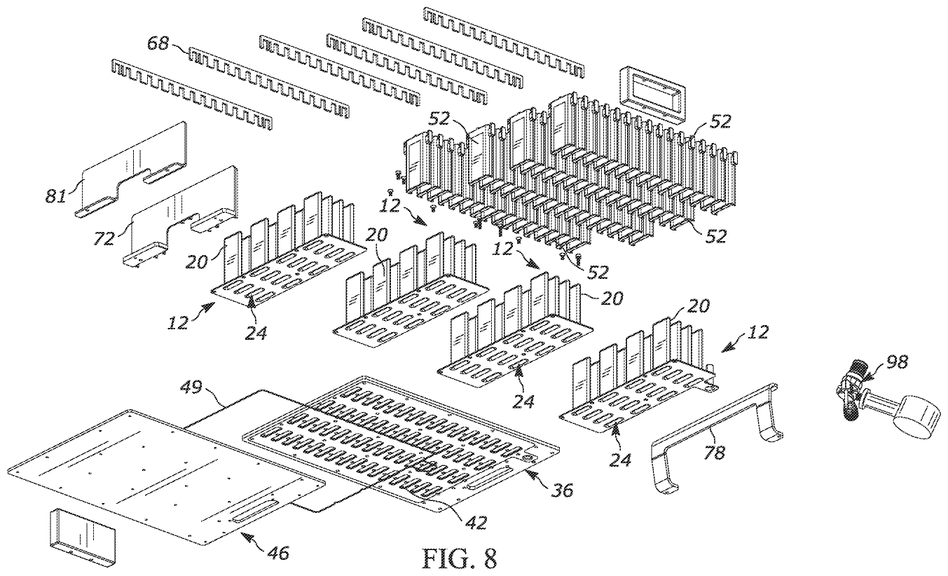

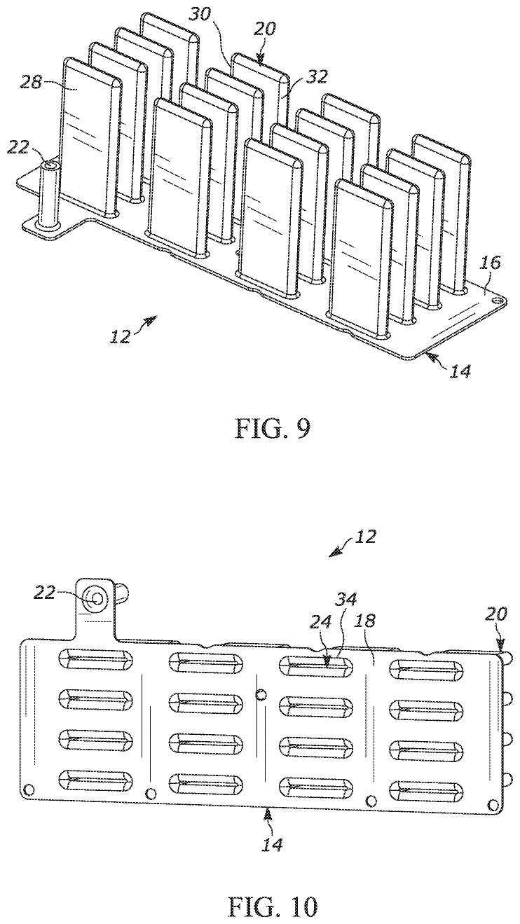

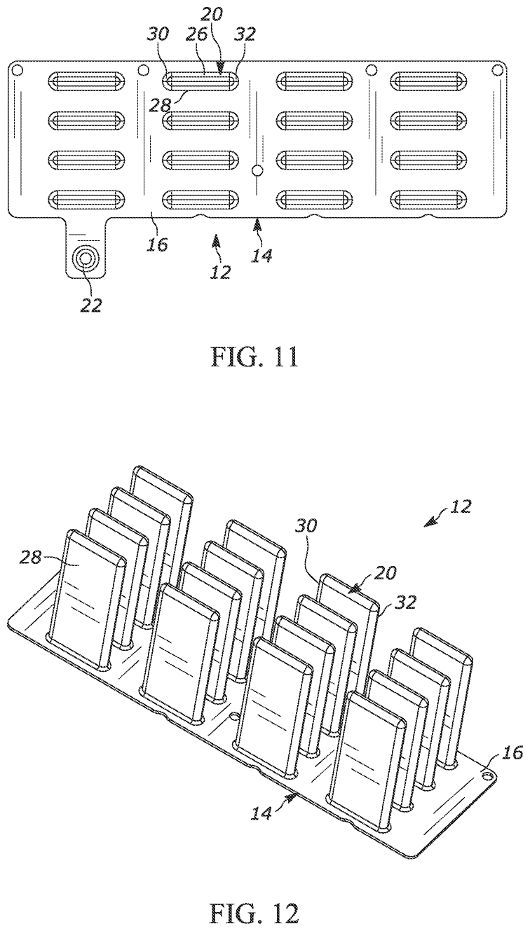

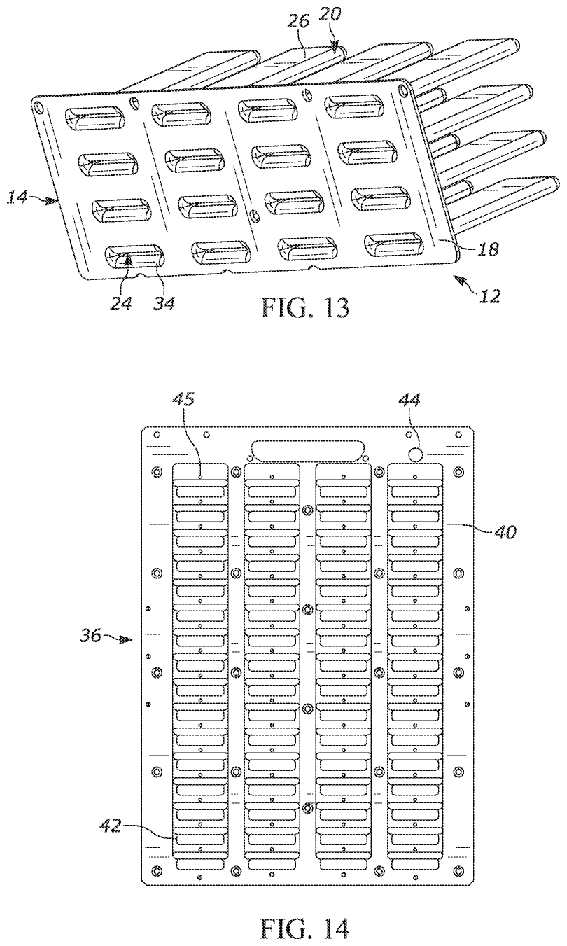

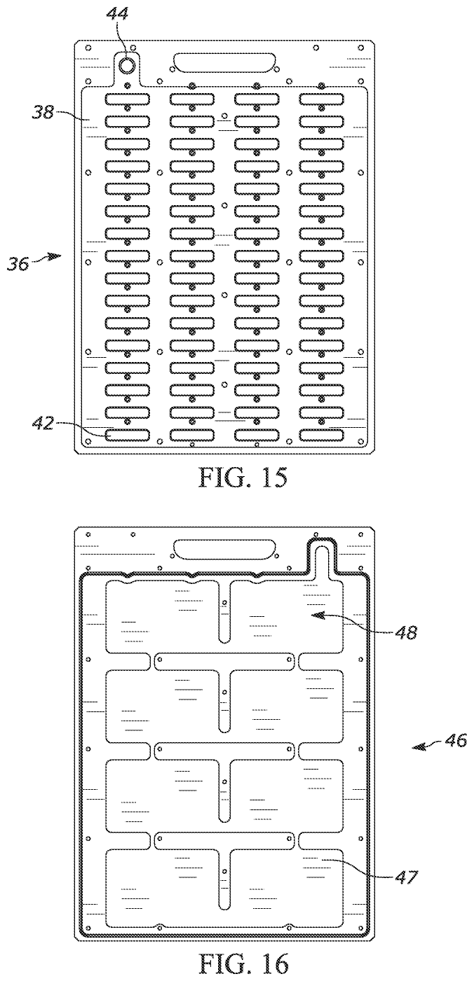

Referring to FIGS. 1-8 an exemplary embodiment of a battery cell pressure fixture 10 is illustrated in front top perspective, rear top perspective, rear bottom perspective, side, top, cross-sectional, exploded top perspective, and exploded bottom perspective views. The fixture 10 includes one or more resilient fluid expansive bladders 12. FIGS. 9-11 illustrate exemplary views of the bladder 12 including front perspective, bottom perspective, and top views. In at least some embodiments, the bladder 12 includes a base 14 having a base top surface 16 and a base bottom surface 18, with a plurality of pillars 20 extending from the base top surface 16, wherein the pillars 20 can be aligned linearly to form spaced rows and columns. In at least some embodiments, the base 14 is generally planar and the pillars 20 extend vertically and perpendicular to the base top surface 16. In at least some embodiments, the bladder 12 includes a fluid inlet 22 that extends through the base 14, while in other embodiments, the bladder 12 omits the fluid inlet 22, such as shown in FIGS. 12-13.

The pillars 20 include a hollow inflatable pillar inner chamber 24 formed by a pillar rear wall 26 interconnected to a pillar front wall 28 by pillar sidewalls 30, 32. The pillar inner chamber 24 receives fluid through a chamber aperture 34 in the base bottom surface 18. In at least some embodiments, the pillar rear wall 26 and pillar front wall 28 are planar, although in other embodiments, they can vary in shape and size to accommodate various shapes of battery cells. The bladder 12 can be comprised of one or more of various materials that allow for resilient expansion of the pillar inner chamber 24, such as rubber, although any flexible resilient material capable of cyclic pressurization can be used. In at least some embodiments, the bladder material is non-conductive.

The fixture 10 further includes an upper tray 36 having an upper tray bottom surface 38 and an upper tray top surface 40, with a plurality of pillar slots 42 extending therethrough. The pillar slots 42 are generally sized and shaped to receive the pillars 20 therethrough, as such, in some embodiments, they are elongated slots, while in other embodiments the pillar slots 42 can include other shapes to match alternate pillar shapes. Similarly, although the pillar slots 42 can be generally linearly arranged in rows and columns to align with the pillar configuration on the base 14 to allow for fitment of the pillars 20 through the pillar slots 42, in other embodiments, the pillar slots 42 can include other layout configurations to match alternate pillar 20 layout configurations. The upper tray 36 can also include an aperture 44 for the fluid inlet 22 to pass through. A plurality of fastener apertures 45 can be provided for receiving fasteners to secure battery cell mounts (discussed below) to the upper tray top surface 40.

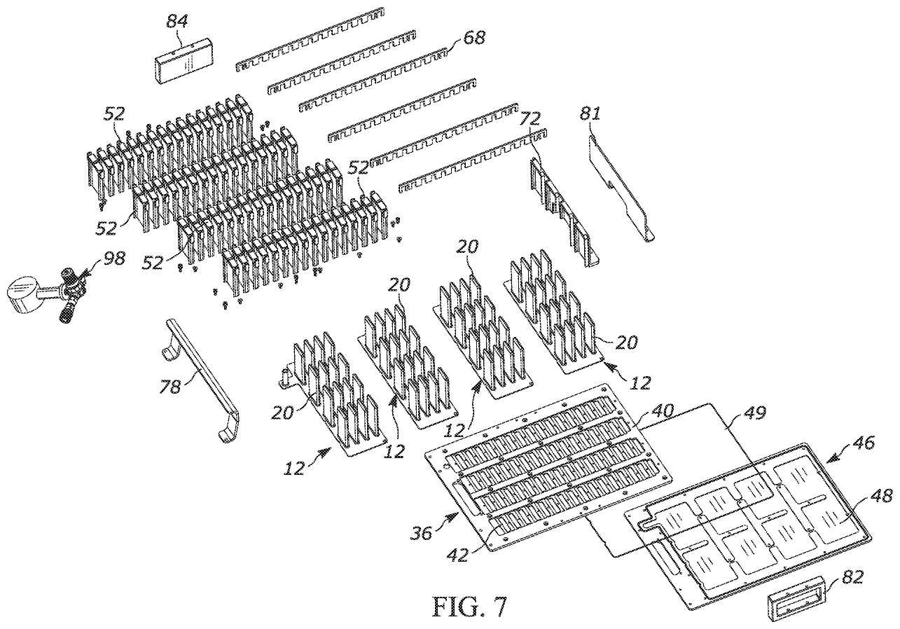

The fixture can further include a lower tray 46 having a lower tray top surface 47 forming a fluid cavity 48, wherein the lower tray 46 is securable to the upper tray 36 via a plurality of fasteners, such as screws. FIG. 16 provides a top view of the exemplary lower tray 46. The fluid cavity 48 can take many forms, in at least some embodiments, it is comprised of one or more depressions in the lower tray top surface 47. A sealing gasket 49 (see FIG. 7) can be provided between the upper tray 36 and the lower tray 46 to provide a fluid seal therebetween. The upper tray 36 and the lower tray 46 can take many forms, although they are generally planar and sized and shaped to allow for a fluid gap 50 when secured together to allow fluid to be passed into the fluid cavity 48, through the chamber apertures 34 and into the pillar inner chambers 24. In at least some embodiments, the fluid gap 50 generally extends between the base bottom surface 18 and the lower tray top surface 47, and can range from 0.25 mm to 3 mm, while in other embodiments, the fluid gap 50 can be greater than 3 mm or less than 0.25 mm. In at least some embodiments, the upper tray 36 and lower tray 46 are comprised of a non-conductive material, while in other embodiments, they can be comprised of metal and/or metal with a non-conductive coating. In at least some embodiments, the upper tray 36 and/or lower tray 46 are not tray-shaped and can take other forms.

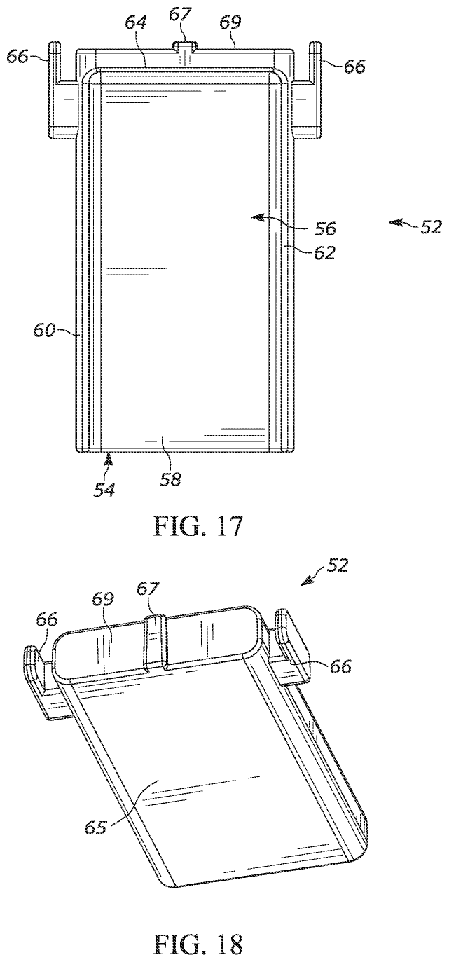

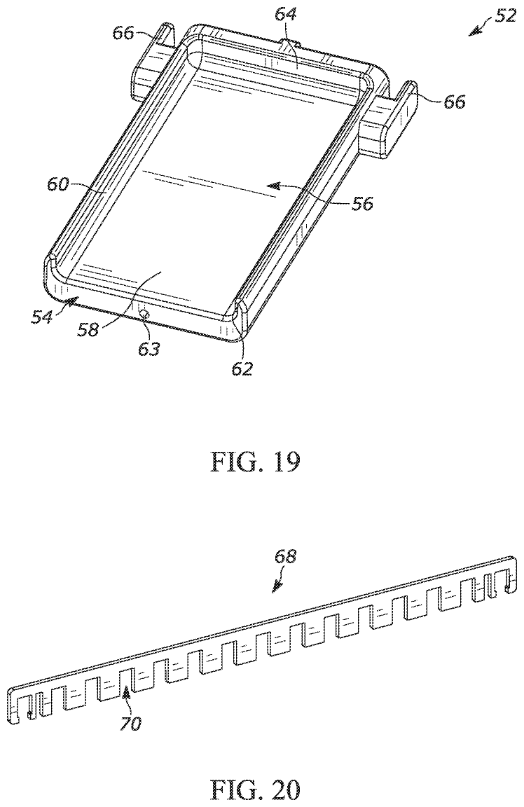

The fixture 10 further includes a plurality of battery cell mounts 52. FIGS. 17-19 illustrate front, rear top perspective, and front bottom perspective views of an exemplary battery cell mount 52. In at least some embodiments, the cell mount 52 is fastened to the upper tray 36 by a fastener, such as screw, and therefore extends from the upper tray top surface 40, while in other embodiments, the cell mount 52 can be formed wholly or partially integral with the upper tray 36. In at least some embodiments, the cell mount 52 is comprised of a non-conductive material, such as a rigid ABS plastic, although other conductive or non-conductive materials can be utilized.

The cell mount 52 includes an elongated cell mount support wall 54 that extends perpendicular or substantially perpendicular to the upper tray top surface 40 (when secured to or formed with the upper tray 36). The cell mount 52 includes a pillar support cavity 56 configured to accommodate and support portions of the pillar 20 during expansion. In at least some embodiments, the pillar support cavity 56 is formed by a cell mount front surface 58 of the cell mount support wall 54 and cell mount side walls 60, 62 and cell mount top wall 64, which extend forwardly from the cell mount support wall 54. In at least some embodiments, the pillar support cavity 56 is sized and shaped to receive the pillar 20 at least partially therein, with the pillar rear wall 26 facing the cell mount front surface 58, and the pillar sidewalls 30, 32 facing the cell mount side walls 60, 62. The cell mount support wall 54 further includes a cell mount rear surface 65 opposite the cell mount front surface 58. The cell mount rear surface 65 is shaped and sized for abutment with a battery cell (discussed below). As such, it can take many forms, although generally it is planar in shape, but in at least some embodiments, it can be modified to accommodate any battery cell shape. The cell mount 52 can further include a plurality of support arms 66 extending therefrom, and a battery cell electrode alignment ridge 67, wherein the alignment ridge 67 extends upwards from a cell mount top surface 69 and perpendicular to the cell mount rear surface 65. The cell mount 52 can further include a fastening aperture 63 for use with a fastener to secure the cell mount 52 to the upper tray top surface 40. In at least some embodiments, the cell mounts 52 are generally linearly arranged in rows and columns to align with the pillars 20, although other configurations can be provided to accommodate alternate pillar 20 configurations.

Referring to FIG. 20, the fixture 10 can further include a plurality of support bars 68 each having a plurality of spaced notches 70 for engaging respective support arms 66, wherein the support bars 68 serve to support and maintain the vertical position and spacing of the cell mounts 52 during fluid pressurization of the bladder 12. In at least some embodiments, the support arms 66 are metal, although other rigid materials, such as ABS plastic can be utilized.

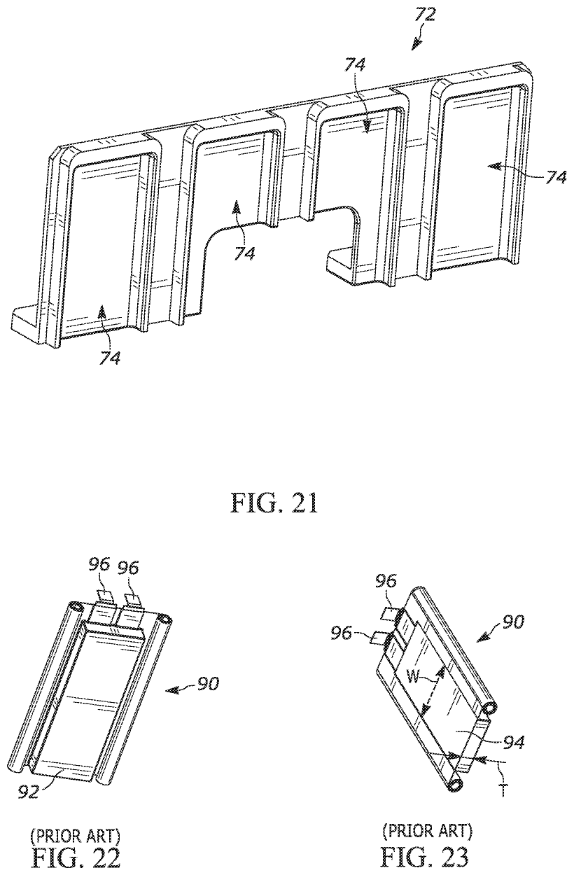

Referring to FIG. 21, the fixture 10 can further include an end plate 72. The end plate 72 includes support cavities 74, that are similar in shape and function to the pillar support cavities 56 and provide support for the pillars 20 situated at the rear 76 of the fixture 10. Although individual cell mounts 52 can be provided instead, providing the end plate 72 that includes a plurality of support cavity 74 can be more economical and provide additional structural rigidity to the fixture 10.

Referring again to FIGS. 1-8, the fixture 10 can further include a front support 78, secured along the front 80 of the fixture 10 to support the cell mounts 52 along the front 80, and a rear support 81 can be situated at the rear 76 to support the end plate 72 A pair of convenience handles 82, 84 can be provided as well, and secured along the upper tray 36.

Referring to FIGS. 22-23, for illustrative purposes only, an exemplary prior art battery cell 90 is shown in respective rear top perspective and front bottom perspective views. As shown, the battery cell 90 has a rear surface 92, a front surface 94 and a pair of electrodes 96, as well as a thickness T that is much less than a width W. References herein to battery cell 90 shall not be limited to the exemplary illustration.

The fixture 10 receives a supply of fluid to inflate the pillars 20. The fluid can include any of various types of fluid, including gases or liquids, such as air. A regulator 98 coupled to the fluid inlet 22 can regulate the supply and pressure of the fluid into the pillar inner chambers 24 to selectively expand and pressurize the pillars 20 as desired. The regulator 98 can include ON/OFF and adjustable pressure setting functions, or can include a separate valve for the ON/OFF function. In at least some embodiments, the regulator 98 is a stand-alone mechanical valve, while in other embodiments, the regulator 98 can be computer controlled to maintain a set pressure and/or turn on/off the supply of fluid pressure based on a various criteria, such as time and temperature.

In at least some embodiments the fixture 10 can include a pressurized fluid reservoir, and further can include one or more temperature sensors to sense the fluid temperature, wherein fluid can be added via the pressurized fluid reservoir (or a dedicated fluid line) in communication with the fluid cavity 48 to compensate for a drop in temperature, thereby maintaining a set pressure in the fluid cavity 48. In addition, the fixture 10 can further include a heating element and/or a thermo-electric cooling device (e.g., Peltier device) coupled with the lower tray 46 to maintain a set fluid temperature.

In at least some embodiments, to assemble the fixture 10, the cell mounts 52 are fastened to the upper tray top surface 40 and the pillars 20 are inserted through the pillar slots 42 of the upper tray 36. The lower tray 46 is secured to the upper tray 36 to sandwich the base 14 therebetween and provide the fluid gap 50. As best seen in FIG. 7, in at least some embodiments, only one bladder 12 needs to include the fluid inlet 22, which is passed through the aperture 44 in the upper tray 36 for coupling with a fluid supply, such as regulator 98 to supply fluid to the fluid cavity 48; as the other bladders 12 are in communication with the fluid cavity 48. Due to the modularity of the bladders 12 and cell mounts 52, it is apparent that the upper and lower trays 36, 46 can be reduced or enlarged to accommodate more or less bladders 12 and cell mounts 52. In addition, the spacing of the pillars 20, pillar slots 42, and cell mounts 52 can be modified to accommodate larger or smaller numbers of battery cells, as well as battery cell sizes, as such, the illustrated dimensions and quantities of elements shown are merely exemplary of one possible configuration.

The plurality of cell mounts 52 and pillars 20 are spaced, such that the pillar front walls 28 face the cell mount rear surfaces 65 to form a plurality of battery receptacles 102 (see FIGS. 1, 2, 4, etc.) in the spaces between the pillar front walls 28, the cell mount rear surfaces 65, and the upper tray top surface 40. In the illustrated configuration, each battery receptacle 102 is open at the top allowing a battery cell 90 to be placed inside.

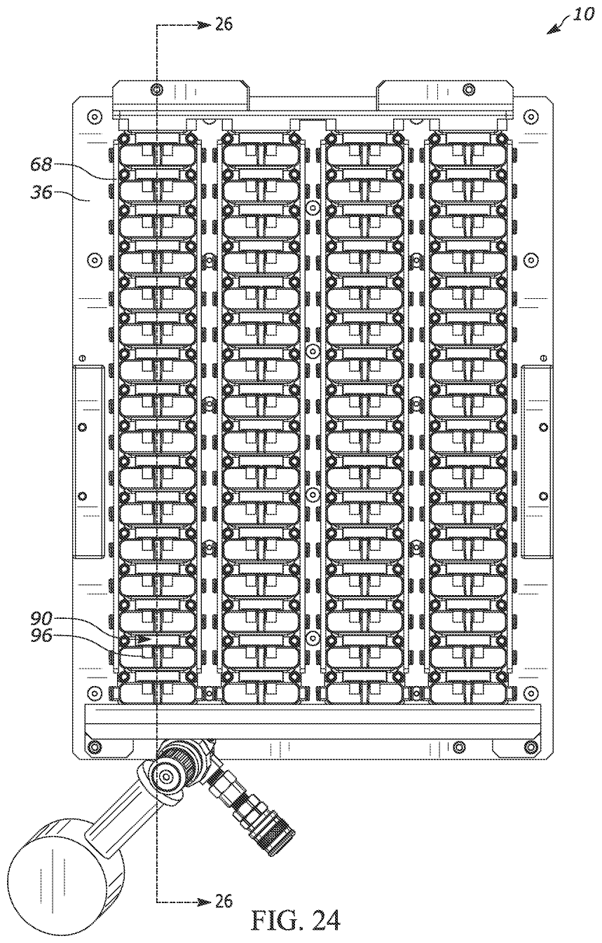

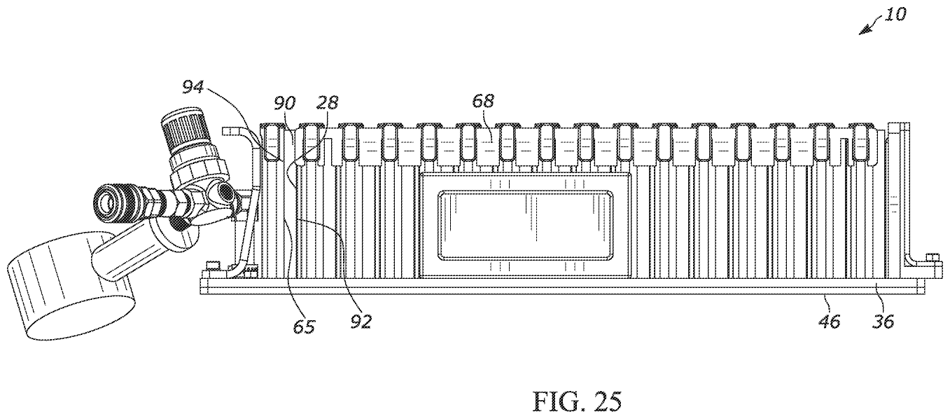

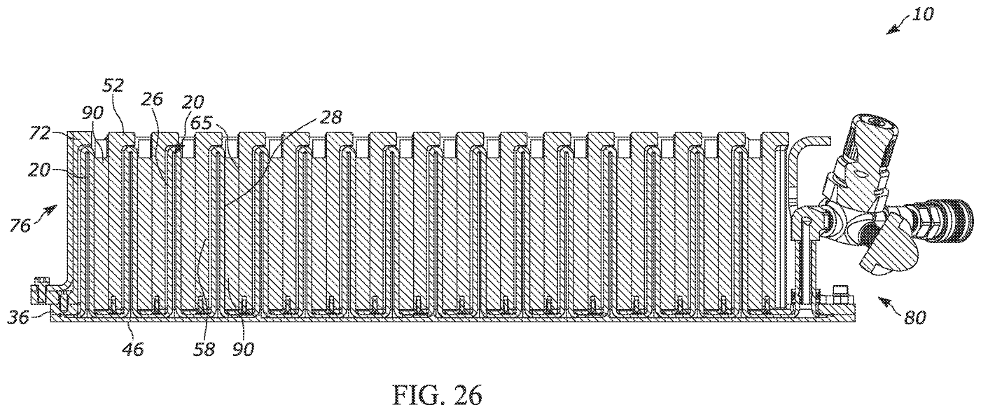

Referring now to FIGS. 24-26, the fixture 10 is shown with uncharged battery cells 90 positioned with the plurality of battery receptacles 102. Prior to supplying fluid pressure, the bladders 12 are in a deflated condition, thereby allowing battery cells 90 to be easily inserted into the battery receptacles 102. As best seen in the side and cross-sectional views of FIGS. 25 and 26, the front surface 94 of the battery cell 90 is in abutment with the cell mount rear surface 65, while the rear surface 92 of the battery cell 90 is in abutment with the pillar front wall 28. The electrodes 96 of the battery cell 90 are positioned across the cell mount top surface 69 and along the battery cell electrode alignment ridge 67.

After the battery cells 90 are inserted into the battery receptacles 102, just prior to, or after the charging cycle begins, an operator or an automated system, begins to supply pressurized fluid into the fluid inlet 22. The fluid fills the fluid gap 50 in the fluid cavity 48 and then proceeds to fill the pillar inner chambers 24, causing expansion of the pillars 20. As the pillars 20 expand, the pillar rear walls 26 and pillar sidewalls 30, 32 abut (or caused to abut with) the cell mount support walls 54 and cell mount side walls 60, 62 of the pillar support cavities 56, forcing the pillar front walls 28 forcibly against the rear surfaces 92 of the battery cells 90, thereby pushing the front surfaces 94 of the battery cells 90 forcibly against the cell mount rear surfaces 65 to provide compressive forces on both surfaces 92, 94 of the battery cell 90 to minimize expansion of the battery cell thickness during charging. The compressive force applied to the battery cells 90 is uniform, such that the force on each battery cell 90 is equal or substantially equal, regardless of slight variations in the dimensions of the battery cell, as each pillar 20 will expand until the forces thereon are the same, allowing a pillar 20 in abutment with a thinner battery cell to expand more than a pillar 20 in abutment with a thicker battery cell.

The operator or automated system can inflate the bladders 12 to any desired fluid pressure. Once the desired fluid pressure is achieved to forcibly secure the battery cells 90, charging of the battery cells 90 can begin, if it has not already. Once charging is complete, the fluid pressure is relieved and the battery cells 90 can be removed from the battery receptacles 102. In at least some embodiments, as the expansion of the pillars 20 may in some circumstances cause undesirable movement of the cell mounts 52, prior to inflating the bladders 12, the support bars 68 can be coupled with the support arms 66 along each row of cell mounts 52 to assist with maintaining even spacing between the cell mounts 52. Although fluid pressure supplied to the bladders 12 can vary depending on bladder material, battery cell composition, etc., in at least some embodiments, the fluid pressure supplied to the fixture 10 can range from 3-6psi, while in other embodiments, the fluid pressure can be higher than 6psi or lower than 3psi.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein. The term “plurality” as used herein shall be understood to include one or more.

What is claimed is:

1. A battery cell pressure fixture comprising:
a lower tray;
an upper tray having an upper tray top surface and a plurality of pillar slots extending therethrough;
a plurality of battery cell mounts, each having an elongated cell mount support wall and extending from the upper tray top surface; and
a resilient fluid expansive bladder for receiving a supply of pressurized fluid and having a base with a plurality of pillars extending from a base top surface, wherein the base is positioned between the lower tray and the upper tray, and the pillars extend upward through the pillar slots opposite the lower tray.

2. The battery cell pressure fixture of claim 1, wherein the plurality of pillars are spaced and fluidly connected, and wherein the plurality of pillars each include an inflatable pillar inner chamber formed by a pillar rear wall interconnected to a pillar front wall by pillar side walls.

3. The battery cell pressure fixture of claim 2, wherein the plurality of battery cell mounts include a pillar support cavity formed by a front surface of the cell mount support wall and a cell mount top wall and cell mount side walls, which extend from the cell mount support wall.

4. The battery cell pressure fixture of claim 3, wherein the plurality of pillars are positioned at least partially in the pillar support cavities with the pillar rear walls facing the front surfaces of the cell mount support walls.

5. The battery cell pressure fixture of claim 4, wherein the plurality of battery cell mounts and plurality of pillars are linearly spaced, such that the pillar front walls face cell mount rear surfaces, and wherein a plurality of battery receptacles are formed in the spaces between the pillar front walls, the cell mount rear surfaces, and the upper tray top surface.

6. The battery cell pressure fixture of claim 5, wherein each of the plurality of battery receptacles is configured to receive a battery cell therein.

7. The battery cell pressure fixture of claim 6, wherein each of the plurality of battery receptacles applies pressure to respective battery cells positioned therein when the plurality of pillars are expanded via a supply of pressurized fluid into the bladder.

8. The battery cell pressure fixture of claim 7, wherein the plurality of battery cell mounts further include support arms extending therefrom.

9. The battery cell pressure fixture of claim 8, further comprising a plurality of support bars including spaced notches for engaging respective the support arms, wherein the support bars secure the position of the plurality of battery cell mounts during pressurization of the bladder.

10. The battery cell pressure fixture of claim 9, wherein the plurality of battery cell mounts further include battery cell electrode alignment ridges, wherein each alignment ridge extends upwards from a cell mount top surface and perpendicular to the cell mount rear surface.

11. The battery cell pressure fixture of claim 2, wherein the base of the bladder includes a plurality of fluid apertures that extend from a base bottom surface into the pillar inner chambers of the plurality of pillars.

12. The battery cell pressure fixture of claim 11, wherein the bladder includes a fluid inlet port that extends through the base for passing a supply of pressurized fluid between the base bottom surface and a fluid cavity in the lower tray.

13. The battery cell pressure fixture of claim 12, further comprising, a valve positioned between a supply of pressurized gas and the fluid inlet port, wherein the valve controls the fluid pressure inside the pillar inner chambers.

14. The battery cell pressure fixture of claim 1, wherein two or more bladders are provided.

15. The battery cell pressure fixture of claim 14, wherein the plurality of battery cell mounts are fastened to the upper tray.

16. A battery cell pressure fixture comprising:
a lower tray;
an upper tray having an upper tray top surface and a plurality of pillar slots extending therethrough, wherein the upper tray is secured to the lower tray;
a plurality of battery cell mounts, each having an elongated cell mount support wall and extending from the upper tray top surface;
a first resilient fluid expansive bladder for receiving a supply of pressurized fluid and having a base with a plurality of pillars extending from a base top surface, wherein the base is positioned between the lower tray and the upper tray, and the pillars extend upward through the pillar slots opposite the lower tray;
a plurality of fluid apertures that extend from a base of the bladder into pillar inner chambers of the plurality of pillars; and
a plurality of battery receptacles for receiving battery cells therein, the battery receptacles formed by the upper tray, the pillars, and the battery cell mounts, and wherein the pillars expand under fluid pressure applied to the pillar inner chambers to provide a uniform compressive force to the battery cells.

17. The battery cell pressure fixture of claim 16, wherein the lower tray includes a fluid cavity and a fluid gap extends between a lower tray bottom surface and base bottom surface.

18. The battery cell pressure fixture of claim 17, wherein supplied fluid pressure is communicated to the fluid cavity through a fluid inlet and dispersed to the pillar inner chambers.

19. The battery cell pressure fixture of claim 18, wherein two or more bladders are provided, and wherein the plurality of pillars and plurality of battery cell mounts are linearly arranged in rows and columns.

20. A battery cell pressure fixture comprising:
a fluid cavity for receiving a fluid pressure;
an expandable bladder having a plurality of pillars with pillar inner chambers in communication with the fluid cavity;
a plurality of battery cell mounts positioned adjacent the pillars; and
a plurality of battery receptacles for receiving battery cells therein, the battery receptacles formed at least in part by the pillars and the battery cell mounts, wherein each battery receptacle provides a compressive force to a received battery cell positioned therein when fluid pressure is supplied to the fluid cavity.
